(19) United States
(12) Patent Application Publication
(10) Pub. No.: US 2004/0114898 A1
(43) Pub. Date: Jun. 17, 2004

(54) Optical transmission system having hollow metal light channel

(76) Inventors: Donald Sidney Hanson, Novi, MI (US); Harvinder Singh, Shelby Twp., MI (US); Bernard A. Meyer, Taylor, MI (US)

Correspondence Address: VISTEON 29074, BRINKS HOFER GILSON & LIONE, P.O. BOX 10395, CHICAGO, IL, 60611, US

(21) Appl. No.: 10/319,959

(22) Filed: Dec. 16, 2002

(51) Int. Cl. G02B 6/20

(52) U.S. Cl. 385/125

(57) ABSTRACT

An optical signal transmission system comprises a metal conduit for transmitting optical signals between an optical signal transmitter and an optical signal receiver. The metal conduit is preferably formed of metal tubing and defines a hollow light channel containing air or other gas through which light propagates. In one aspect, metal conduits are interconnected by a polymeric coupling that transmits light between hollow light channels without loss due to misalignment or gaps between the channels.

### TECHNICAL FIELD OF THE INVENTION

This invention relates to an optical transmission system that includes a metal conduit that defines a hollow light channel for transmitting optical signals. In one aspect, this invention relates to such optical signal transmission system wherein hollow metal light channels are interconnected by a solid transparent coupling.

### BACKGROUND OF THE INVENTION

It is known to communicate data by optical signals transmitted through a waveguide between an optical transmitter and an optical receiver. A preferred waveguide for transmitting data is a solid transparent fiber formed of glass or polymer having a high index of refraction relative to the surrounding medium. As light propagates through the fiber, the high index of refraction causes light to be internally reflected at the fiber surfaces and contained within the fiber. Such internal reflection is highly efficient, as compared, for example, to spectral reflection of light off a mirror surface which may result in light loss on the order of 5 percent. As a result, signals may be transmitted over long distances with little loss in signal intensity.

One problem with optical fibers is that the materials tend to deteriorate when exposed to environments that include high temperatures or chemical solvents, conditions found, for example, on-board an automotive vehicle. For example, glass fibers degrade when exposed to temperatures above their glass transition temperatures, typically between 100° C. and 150° C. Polymeric fibers are typically formed of polycarbonate or polyacrylate compounds and are susceptible to degradation by solvents, such as found in gasoline, anti-freeze, motor oil or other automotive fluids. Therefore, when used on-board an automotive vehicle, optical fibers require careful placement and protection from conditions that might cause deterioration in performance.

Therefore, a need exists for a robust optical transmission system that allows optical signals to be transmitted reliably in an environment that includes high temperature, chemical solvents or other conditions that tend to degrade glass or polymeric materials.

### BRIEF SUMMARY OF THE INVENTION

In accordance with this invention, an optical signal transmission system comprises a metal conduit for transmitting optical signals between an optical transmitter and an optical receiver. The metal conduit is preferably formed of metal tubing and defines a hollow light channel. As used herein, hollow channel refers to a channel containing air or other transparent gas, as opposed to a solid or a liquid medium. An optical signal is emitted by the transmitter into the hollow light channel and propagates through the conduit by spectral reflection off the metal surfaces that border the channel.

In one aspect of this invention, a coupling is provided for forming an optical connection between metal conduits defining hollow light channels. The first conduit is operatively connected to the optical signal transmitter and includes a distal end. Similarly, the second metal conduit is operatively connected to the receiver and includes a distal end. The coupling is formed of a solid transparent polymeric material and includes a first coupling end received in the distal end of the first conduit in optical communication with the hollow light channel therein, and a second end received in the distal end of the second metal conduit in optical communication with the hollow light channel therein. Light propagating from the transmitter through the hollow light channel of the first metal conduit is admitted through the first coupling end, travels through the coupling to the second coupling end, and is emitted into the hollow light channel of the second metal conduit for transmission to the receiver. The use of a polymeric coupling transmits light between the hollow light channels with high efficiency and reduces loss of signal intensity that might occur due to misalignment of the channels or gaps between the distal ends.

### BRIEF DESCRIPTION OF THE DRAWINGS

This invention will be more particularly described with reference to the following figures wherein:

FIG. 1 is a view of an optical transmission system comprising a hollow metallic conduit in accordance with this invention; and

FIG. 2 is a view of an optical transmission system comprising an optical coupling between hollow metallic conduits in accordance with one aspect of this invention.

### DETAILED DESCRIPTION OF THE INVENTION

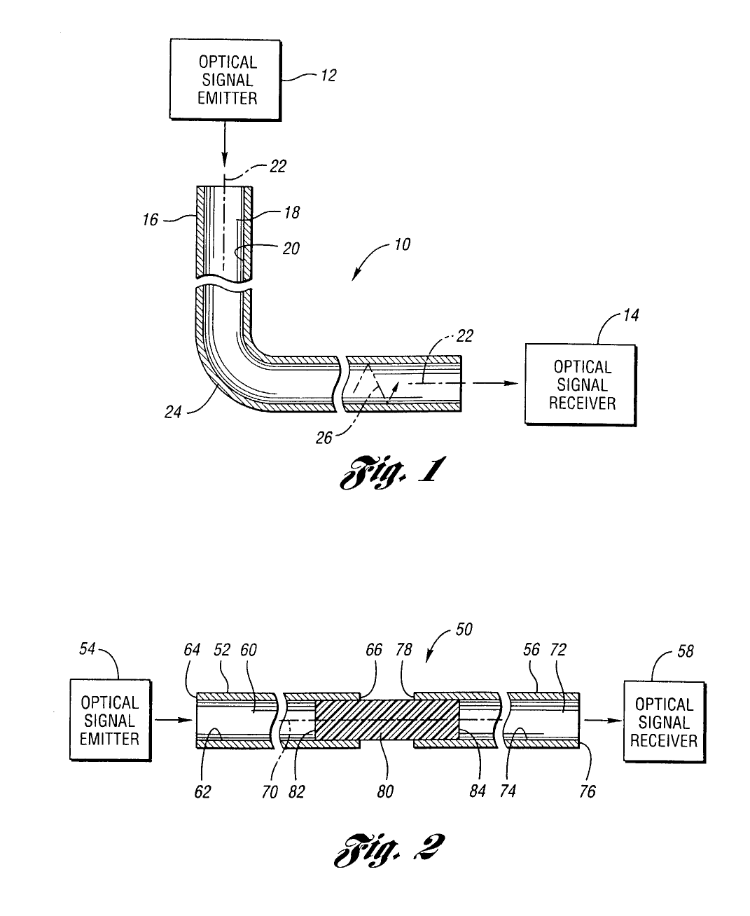

In accordance with a preferred embodiment of this invention, referring to FIG. 1, an optical transmission system 10 comprises an optical signal emitter 12 optically coupled to an optical signal receiver 14 through a hollow metallic conduit 16.

A preferred optical signal emitter 12 is an infrared light emitting diode, referred to as IR LED. Other suitable emitters include LED's that emit visible or near infrared light. The emitted light may be either collimated or uncollimated.

A preferred optical signal receiver 14 is an infrared receiver. Other suitable optical signal receivers may be used depending on the nature of the signal from the emitter.

Hollow metal conduit 16 is preferably an elongated tube formed of a metal having high spectral reflectance. Conduit 16 includes a hollow light channel 18 defined by an inner metal surface 20 and having a circular cross section about a central axis 22. Surface 20 circumferentially surrounds the channel along the entire length. In this example, conduit 16 includes a bend 24 for directing the light along a desired nonlinear path between emitter 12 and receiver 14. A preferred metal conduit 16 is copper tubing having an inner diameter of between about 0.2 and 2.5 centimeters. In particular, tubing having diameters between about 0.2 and 1.0 centimeters is commonly available with uniform inner surfaces and is readily bent to a desired configuration.

During use, light is emitted from emitter 12 into the proximal end of hollow conduit 16. The optical signal includes light rays that are not parallel to axis 22. As the optical signal propagates through light channel 18, the rays intersect metal surface 20 and are spectrally reflected, as indicated by arrow 26. The optical signal thus travels through hollow conduit 16 and is emitted from the distal end of the conduit to be received by receiver 14.

As the optical signal propagates through the conduit, a portion of the light intersecting the inner metal surface is not reflected, resulting in a loss in signal intensity. In general, the signal loss is proportional to the square of the length of the light channel. Referring to the Table, there is reported a percentage of signal intensity as a function of distance calculated for an optical signal emitted by an LED and having a 10° half angle. While optical transmission is dependant upon the original intensity and the sensitivity of the optical receiver, the Table shows that this invention is particularly suited for transmitting signals over distances up to several centimeters while retaining greater than half original signal intensity.

TABLE

| | | Percentage of Original |
|---|---|---|
| | Percentage of Original | Signal |
| | Signal | for 0.64 cm (0.25 in.) |
| Channel Length | for 2.5 cm (1 in.) Diameter | Diameter |
| 10 cm (4 in.) | 95 | 82 |
| 15 cm (6 in.) | 92 | 75 |
| 20 cm (8 in.) | 91 | 68 |
| 25 cm (10 in.) | 88 | 62 |
| 30 cm (12 in.) | 86 | 47 |
| 36 cm (14 in.) | 85 | 52 |

The metal tubing that forms a preferred hollow metal conduit is readily bent into a self-sustaining shape for a desired light path between the emitter and the receiver. Nevertheless, difficulty may be encountered in maneuvering the conduit to accurately align the ends with the emitter or receiver during assembly. A convenient approach is to align the emitter and receiver with hollow metal conduits in subassemblies and interconnect the hollow metal conduits to complete the optical path between the emitter and receiver. Referring to FIG. 2, there is depicted an optical transmission system 50 that includes a first hollow metal conduit 52 operatively connected to an optical signal emitter 54 and connected to a second hollow metal conduit 56 operatively connected to an optical signal receiver 58. First metal conduit 52 comprises a hollow light channel 60 defined by a inner metal surface 62. Conduit 52 is coupled to the emitter at a proximal end 64 and includes a distal end 66 symmetrical about a central axis 70. Similarly, second conduit 56 includes a light channel 72 defined by metal surface 74. Second conduit 56 includes a proximal end 76 through which light is emitted to receiver 58 and a distal end 78 also symmetrical about axis 70. A coupling 80 is provided for optically connecting light channel 60 and 72 between ends 66 and 78. Coupling 80 is preferably formed of a solid transparent polymeric material. Coupling 80 includes a first end 82 received into first conduit 52 through end 66 in optical communication with light channel 60, and a second end 84 received in conduit 56 through end 78 in optical communication with light channel 72. Ends 82 and 84 are perpendicular to axis 70 to facilitate light ingress and egress with minimal reflection losses. Coupling 80 is preferably formed of polymer having a high index of refraction to contain light traveling axially therethrough by internal reflection, thereby providing optical communication between ends 82 and 84.

For assembly, first conduit 52 is mounted with emitter 54 to align end 64 with light emitted by emitter 54 to optimize the signal that is received in channel 60. In a separate operation, conduit 56 is mounted in a subassembly with receiver 58 to align end 76 for directing light onto the receiver. The subassemblies are then independently installed in a desired arrangement, and ends 82 and 84 of coupling 80 are inserted through ends 66 and 78 of the conduits to complete an optical connection between channels 60 and 72.

During use, an optical signal is emitted from emitter 54 and received through end 64 into light channel 60. The signal propagates through light channel 60 by internal spectral reflection off inner metal surface 62 and is admitted through end 82 into coupling 80. The optical signal propagates through coupling 80 and is emitted from end 84 into channel 72, whereafter the optical signal propagates by internal reflection off inner metal surface 74 and is emitted through end 76 to receiver 58.

In the embodiment in FIG. 2, coupling 80 is linear along axis 70 and coaxially aligns ends 66 and 78. It is an advantage of this aspect of the invention that coupling 80 provides optical communication between the light channels with high efficiency and prevents loss of signal intensity due to misalignment of the ends or dispersion of light due to spacing between the ends. While in the described embodiment a straight coupling is provided, the coupling may be suitably formed of a polymeric material that may be suitably bent to provide a desired geometry for the optical path between the ends of the hollow metal conduits.

Therefore, this invention provides an optical transmission system that utilizes a hollow metal conduit to form an optical waveguide for conveying optical signals between an emitter and a receiver. The metal conduit not only reflects light to contain the signal within the hollow channel, but also protects the hollow channel from contamination by dirt, solvents or other external materials that might interfere with the transmission. The transmission medium within the channel is air or other gas capable of transmitting light without absorption. In addition, optical transmission is not affected by temperature or other environmental factors. The metal conduit may be suitably bent into a self-sustaining shape to provide a desired geometry for the optical path. Despite light losses due to spectral reflection of light propagating through the metal conduit, the hollow metal conduit is particularly suited for conveying optical signals over distances up to several centimeters while maintaining sufficient signal intensity for reliable communication with the receiver. The invention permits the emitter and receiver to be independently assembled with light channels and independently installed. Optical connections between the metal conduits may be readily and conveniently made to complete the optical path between the emitter and the receiver. By forming the waveguide out of metal, the transmission system avoids the problems associated with use of glass or polymeric optical fibers and thus provides a robust system that may be readily employed in harsh environments, such as in an automotive vehicle.

While this invention has been described in terms of certain embodiments thereof, it is not intended to be so limited, but rather only to the extent set forth in the claims that follow.

1. An optical signal transmission system comprising:
an optical signal transmitter;
an optical signal receiver;
a metal conduit comprising a hollow light channel and having a first end operatively connected to the optical signal transmitter for receiving an optical signal and operatively connected to the optical signal receiver for emitting an optical signal to said optical signal receiver.

2. An optical signal transmission system according to claim 1 wherein the metal conduit comprises metal tubing.

3. An optical signal transmission system according to claim 2 wherein the metal tubing has an inner diameter within a range between 0.2 and 2.5 centimeters.

4. An optical signal transmission system according to claim 2 wherein the metal tubing has an inner diameter within a range between 0.2 and 1.0 centimeters.

5. An optical signal transmission system according to claim 1 wherein the metal conduit includes a bend.

6. An optical signal transmission system according to claim 1 wherein the metal conduit comprises a reflective surface circumferentially about the hollow light channel and is adapted for transmitting signals through the hollow light channel by spectral reflection.

7. An optical signal transmission system comprising:
an optical signal transmitter;
an optical signal receiver;
a first metal conduit comprising a first hollow light channel and a first distal end, said first conduit being operatively connected to the optical signal transmitter for receiving and transmitting an optical signal through said first gas channel to said first distal end;
a second hollow metal conduit comprising a second hollow light channel and a second distal end, said second conduit operatively connected to the optical signal receiver for transmitting an optical signal from said second distal end to said optical signal receiver; and
an optical coupling formed of a solid transparent polymeric material comprising a first coupling end and a second coupling end in optical communication, said first coupling end being received in the first distal end of the first conduit in optical communication with said first hollow light channel, said second coupling end being received in said second distal end of said second conduit in optical communication with said second hollow light channel.

8. An optical signal transmission system according to claim 7 wherein the first hollow light channel is disposed about a central axis adjacent said first distal end and wherein the first coupling end is perpendicular to the first central axis.

9. An optical signal transmission system according to claim 7 wherein the second hollow light channel is disposed about a central axis adjacent the second distal end and wherein the second coupling end is perpendicular to the second central axis.

10. An optical signal transmission system according to claim 7 wherein the optical coupling has an axis and is effective for coaxially aligning said first and second hollow light channels at said distal ends.

11. An optical signal transmission system according to claim 7 wherein the first metal conduit is formed of metal tubing having an inner diameter within a range between 0.2 and 2.5 centimeters.

12. An optical signal transmission system according to claim 7 wherein metal conduit is formed of metal tubing having an inner diameter within a range between 0.2 and 1.0 centimeters.
